(19) United States
(12) Patent Application Publication
(10) Pub. No.: US 2022/0117274 A1
(43) Pub. Date: Apr. 21, 2022

(54) INTELLIGENT COOKING SYSTEM AND METHOD

(71) Applicant: June Life, Inc., San Francisco, CA (US)

(72) Inventors: Nikhil Bhogal, San Francisco, CA (US); Jithendra Paruchuri, San Francisco, CA (US); Robert Cottrell, San Francisco, CA (US)

(21) Appl. No.: 17/506,401

(22) Filed: Oct. 20, 2021

Related U.S. Application Data
(60) Provisional application No. 63/094,165, filed on Oct. 20, 2020.

(51) Int. Cl. A23L 5/10; A47J 37/06; A47J 37/07; A47J 36/32; G05D 23/19

(52) U.S. Cl. CPC A23L 5/15; A47J 37/0623; A23V 2002/00; A47J 36/32; G05D 23/1917; A47J 37/07

(57) ABSTRACT

A method for timer-based cooking can include: heating a cooking cavity to a cooking temperature, detecting an transition event, determining a food classification, determining a cooking time, tracking a food residence time within the cooking cavity, optionally notifying a user when the residence time satisfies the cooking time, and/or any other suitable element.

### CROSS-REFERENCE TO RELATED APPLICATIONS

This application claims the benefit of U.S. Provisional Application No. 63/094,165 filed 20-Oct.-2020, which is incorporated in its entirety by this reference.

### TECHNICAL FIELD

This invention relates generally to the food preparation field, and more specifically to a new and useful cooking system and method in the food preparation field.

### BRIEF DESCRIPTION OF THE FIGURES

FIG. 1 is a flowchart representation of a variant of the method.

FIG. 2 is a schematic representation of a variant of the system.

FIG. 3 is a flowchart representation of a first embodiment of the method.

FIG. 4 is a flowchart representation of a second embodiment of the method, including food instance reinsertion.

FIG. 5 is a flowchart representation of an example of the method.

FIG. 6 is a flowchart representation of an example of the method, including cook time determination.

FIG. 7 is a schematic representation of an embodiment of the food instance matching module.

FIG. 8 is a schematic representation of a first example of the method, including food instance matching.

FIG. 9 is a schematic representation of a second example of the method, including residence tracking resetting.

FIG. 10 is a schematic representation of a third example of the method, including residence tracking resumption.

FIG. 11 is a schematic representation of a fourth example of the method, including residence tracking based on cooking cavity occupancy.

FIGS. 12-14 depict variants of the system.

FIG. 15 is an illustrative example of a variant of the system and method.

### DETAILED DESCRIPTION

The following description of the preferred embodiments of the invention is not intended to limit the invention to these preferred embodiments, but rather to enable any person skilled in the art to make and use this invention.

### 1. Overview

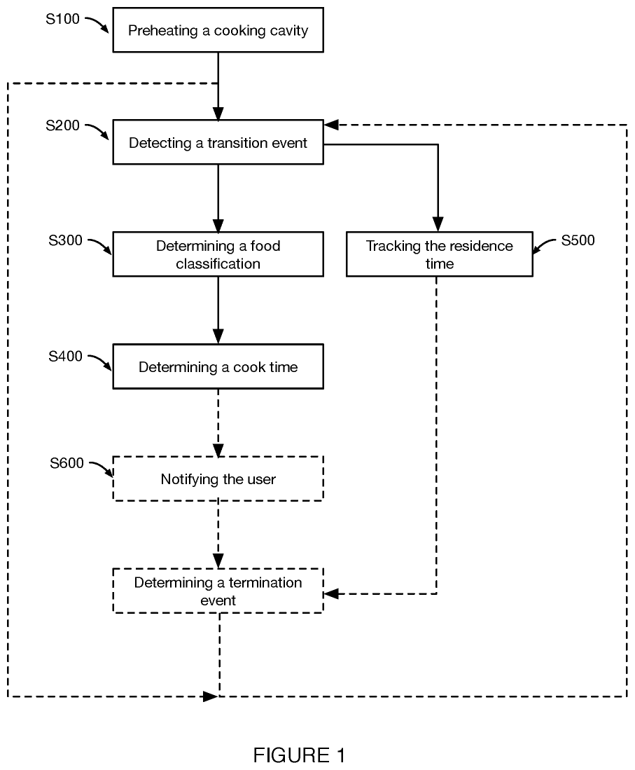

As shown in FIG. 1, the method for intelligent, timer-based cooking can include: heating a cooking cavity to a cooking temperature S100, detecting an transition event S200, determining a food classification S300, determining a cooking time S400, tracking a food residence time within the cooking cavity S500, and/or any other suitable element. The method functions to automatically start, end, and/or restart a timer for time-based cooking.

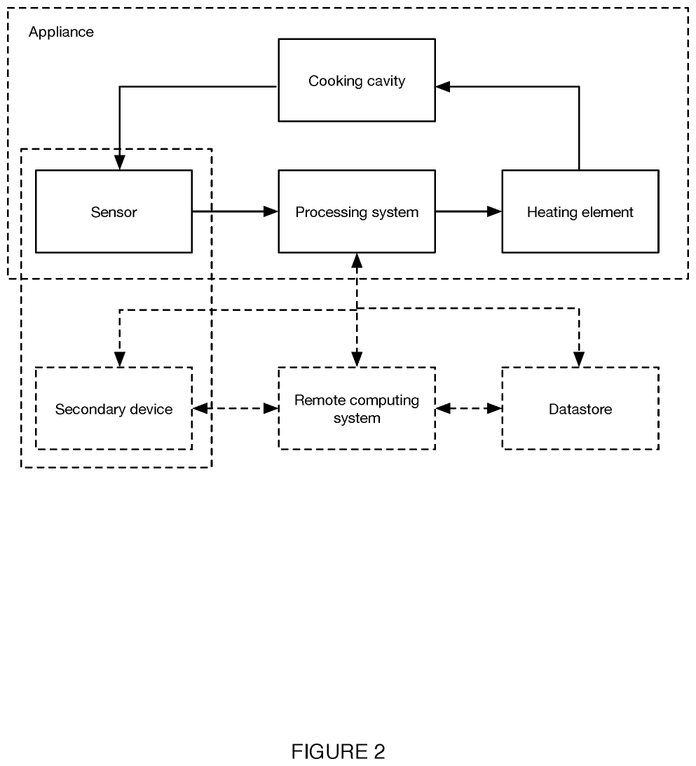

As shown in FIG. 2, the system for intelligent, timer-based cooking can include: an appliance with a cooking cavity and a set of heating elements, a processor, and/or any other suitable components.

One or more variations of the system and/or method can omit one or more of the above elements and/or include a plurality of one or more of the above elements in any suitable order or arrangement.

### 2. Examples

In an example, the method can include: heating a connected cooking appliance to a cooking temperature based on a user input and, rather than dynamically adjusting the baking controls, maintaining the cooking temperature throughout the cooking process; detecting the insertion of an uncooked food instance (e.g., food item); sampling an image of the item acquired via a camera (e.g., a camera inside the appliance or a smartphone camera); analyzing the image to determine a food classification for the food item (e.g., pizza); retrieving a target cook time associated with the food classification; counting up from the insertion time to monitor total time spent cooking (e.g., residence time); and, when the target cook time is reached, sending a notification to a user to ensure the item is not overcooked.

In variations, the method tracks the total residence time for a given food instance within the cooking cavity despite the user removing/re-inserting the instance, re-orienting the food instance (e.g., rotating, flipping, or otherwise moving the item within the appliance cooking cavity), and/or altering the food instance (e.g., adding additional toppings). The method and system can store a final residence time of a given food instance, and can reuse that final residence time in future cooking subsessions (e.g., subsequent bakes in the same cook session for the same food class). The method can also keep track of the residence time of a first cooking subsession for the food item (e.g., grilling meat on one side), wherein that residence time can be used to adjust the target cook time of a second cooking subsession for the same food item (e.g., grilling meat on the other side).

In an illustrative example, a user is batch cooking pizzas one at a time. To eliminate long preheat times, the oven remains at a single temperature during the cook session. During the first pizza bake (e.g., first cook subsession), the method and system keeps track of the residence time until the user removes the pizza. The residence time tracker can be paused when the first pizza is removed from the cooking cavity, and restarted when the first pizza is reinserted. For a subsequent subsession (e.g., for the next pizza), the target cook time is set to the previous final residence time and the user is notified when the residence time of the subsequent pizza satisfies this new target cook time. The method can continually refine the target cook time with each subsequent bake (within the cook session or in other cook sessions).

### 3. Benefits

The technology can confer several benefits over conventional cooking systems and methods.

First, variants of this technology decrease user overhead and provide facile food monitoring. In certain cooking situations, the cooking temperature or heating elements either cannot be tightly controlled, should not be controlled, should remain constant, cannot or should not be dynamically controlled, and/or are controlled independent of the food instance and/or food class. For example, the heat output from charcoal grills cannot be tightly or dynamically controlled. In another example, certain cooking styles or regimens (e.g., pizza baking) call for maximum heat output from the heating elements, and adjusting the heating element output downward (e.g., between pizzas, when one pizza is done, etc.) would be undesirable (e.g., due to the resultant cooking cavity cooling and/or resultant long (re)heating times). In another example, the cooking cavity may already be preheated, and the user may find it inconvenient to cool the cooking cavity down to a different temperature. In another example, cooking cavity temperature deviation (e.g., upward or downward) can be undesirable (e.g., when baking macaroons). By automatically identifying the food, determining the associated cooking time, and automatically monitoring the food residency time, this technology can intelligently cook food to the target consistency without dynamic heating element adjustment (e.g., macro heating element control or shutting off heating element operation).

Second, in variants, the process of counting up to keep track of residence time rather than counting down with a traditional, simple timer can improve the user experience and mitigate the risk of overcooking. In one example, a user is baking an item where the ideal cook time is unknown. Rather than the user manually setting and resetting timers as the user continually checks on the item (e.g., and manually tracking the aggregate cook time for the food instance), this system and method can intelligently keep track of residence time while notifying the user to check on the bake at one or more target cook time(s). In variations, the target cook time can be adjusted based on user response or lack of response to notifications (e.g., explicitly or implicitly indicating the user has checked on the food instance and has chosen not to halt cooking). The final residence time can then be used in subsequent bakes of similar food instances.

Third, variants of this technology enable the personalization of food cooking. The method and system can learn user timer preference on the first food instance from a food batch, then apply that learned time on subsequent cooking sessions. In a specific example, bake time is refined for each subsequent item in batch based on the prior bake time. Additionally or alternatively, this refinement can be based on user input rating the success of the previous bake. This personalization can be performed for known or unknown food classes, wherein unknown foods can be clustered together based on appearance features or otherwise grouped. In a specific example, the system and method can continually add time if user decides the food is not sufficiently cooked or note that the item was finished early if removed earlier than the target cook time. In another specific example, this method can additionally refine the target cook time for other users. In particular, this global refinement can be implemented if a plurality of users cooking a food instance of a given food class are implementing a residence time that deviates from the target (or suggested) cook time.

Fourth, variants of the method can include differentiating the re-insertion of a food instance from the insertion of a new food instance. In a specific example, the method can additionally identify that a food instance has been re-inserted, even with re-orientation and/or alteration. For example, food reinsertion can be identified when a timeseries of cooked food—empty cavity—cooked food is detected from the cavity measurements, when an appearance distance (e.g., using a similarity comparison on features extracted from the image, such as fuzzy matching, cosine distance, etc.) between the prior food instance and the unknown food instance is less than a threshold distance, and/or otherwise identified. In these variants, residency time can be counted against a prior timer associated with the prior residence time when the food is classified as reinserted, and can be counted against a new timer with a reset residence time when the food is classified as new.

Fifth, variants of the method can include adjusting subsequent cooking stages for a given food instance based on the final residence time of the food instance during an earlier cooking stage. In one example, when grilling meat, the method can track the residence time of the meat when grilling on the first side, then subsequently using that first residence time of the first side to adjust the target cook time of the second side. Additionally or alternatively, the first residence time can be used to adjust the cook temperature for subsequent stages. Thus, the appliance can compensate or react to how the user is cooking the food, even if the user's steps are not consistent with the proposed recipe or expected cooking steps.

However, further advantages can be provided by the system and method disclosed herein.

### 4. System

The method is preferably performed using a system including: an appliance including a cooking cavity (e.g., cook cavity) and a set of one or more heating elements, one or more processors, and/or any other suitable components. In an embodiment, the system additionally includes one or more sensors, one or more computing systems (e.g., local, remote, etc.), and one or more datastores, example as shown in FIG. 2. However, the method can be performed with any other suitable system.

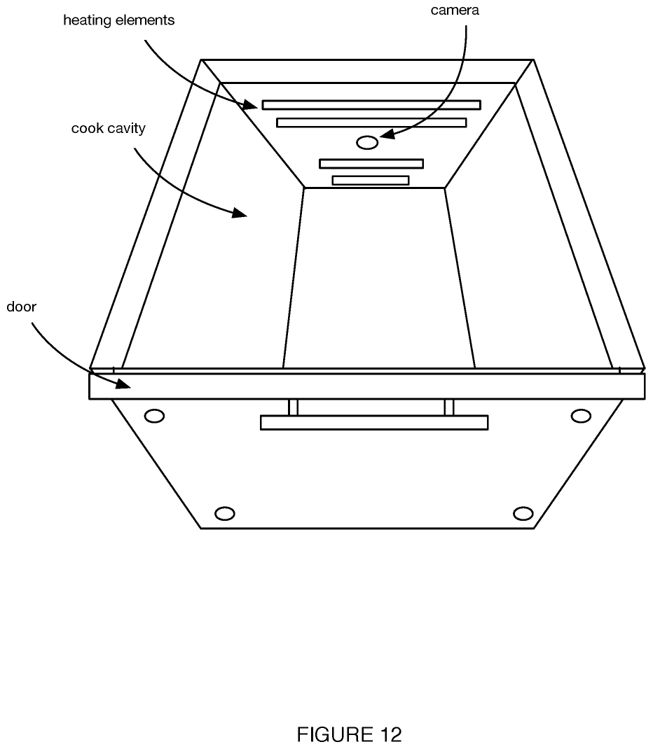

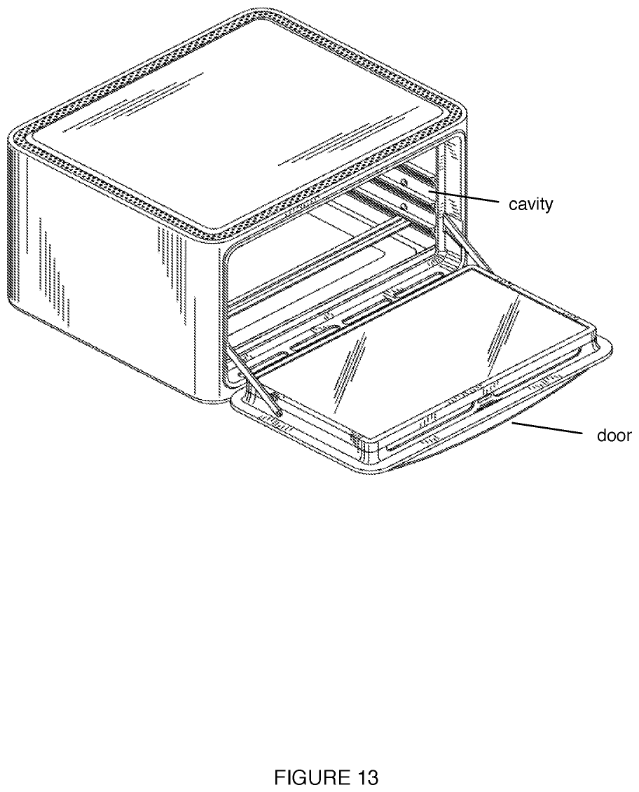

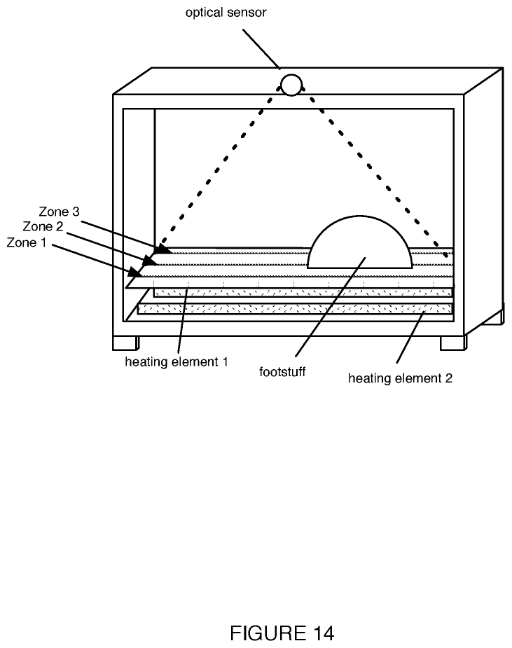

The appliance can function to perform one or more processes of the method. The appliance can include: a housing, which can define a cooking cavity; one or more racks or support surfaces located within the cooking cavity; and one or more heating elements located within or relative to the cooking cavity (e.g., left, right, bottom, top, back, etc.). The appliance can optionally include a sealing component (e.g., a lid, a door, etc.) one or more communication systems (e.g., APIs, Wifi system, cellular system, Bluetooth system, etc.); and/or any other suitable components. The appliance can be a commercial oven, an industrial oven, a conventional oven, a convection oven, a grill (e.g., charcoal grill, electric grill, a gas grill (e.g., using propane or other flammable fuel), a smoker, a pizza oven, an appliance operable above a temperature threshold (e.g., 500° F., 450° F., etc.), and/or any other suitable appliance. Examples of the appliance are depicted in FIGS. 12-14. Examples of appliances that can be used are described in at least U.S. application Ser. No. 16/380,894 filed 10 Apr. 2019, and U.S. application Ser. No. 17/403,472 filed 16 Aug. 2021, each of which is incorporated herein in its entirety by this reference. However, the appliance can be otherwise configured.

The set of one or more heating elements (e.g., 1, 2, 2-10, 3-7, 6, 7, 8, 9, 10-20, more than 20 heating elements, etc.) can be evenly or unevenly distributed along a cavity surface. The heating elements can be positioned on the top of the appliance cavity, the bottom, the sides, the back, and/or otherwise positioned along a cavity surface. The heating elements can direct heat from the top-down, bottom-up, at an angle relative to a gravity vector (e.g., less than 45 degrees, more than 45 degrees, less than 90 degrees, more than 90 degrees, between 30-50 degrees, between 20-170 degrees, etc.), and/or otherwise positioned. The heating elements can be arranged front-to-back, left to right, edge-to-edge, in a grid, array, and/or in any other arrangement. The heating elements are preferably individually addressable and/or controllable, but can alternatively be addressable in particular combinations (e.g., pairs, trios, etc.; such as adjacent pairs, top-bottom pairs, etc.), not individually addressable, or uncontrollable. The heating elements can have adjustable power output (e.g., range from 0-100%, 0-10 associated with the minimum and maximum power, etc.), binary power output, and/or any other suitable power output. The heating elements can be metal, ceramic, carbon fiber, composite (e.g., tubular sheathed heating element, screen-printed metal-ceramic tracks, etc.), biomass (e.g., charcoal, char, etc.), or any other suitable heating element. For example, the heating elements can include standard burner tubes, infrared burner tubes, and/or any other suitable burner tube. The heating elements can transfer heat using conduction, convection, infrared radiation, and/or any other heat transfer technique. The heating elements can apply heat using flames, gas, electric, infrared, and/or any other suitable heating method. The heating elements can each heat a predefined heating zone (e.g., heating area, heating volume, etc.) (e.g., with directed heat, with more than a threshold proportion of the emitted heat, etc.), heat the entire cavity (e.g., with ambient or indirect heat), or otherwise heat the cavity.

In a first specific example, the appliance can include multiple carbon fiber heating elements. The power output of each carbon fiber heating element can be: between 300 W-600 W, between 440 W-460 W, more than 600 W, less than 300 W (e.g., 400 W, 430 W, 450 W, 460 W, 480 W, 500 W, etc.), and/or any other suitable power output. The maximum temperature of the multiple carbon fiber heating elements can be above, below, or equal to: 300° F., 500° F., 700° F., and/or any other suitable temperature.

In a second specific example, the appliance can include multiple light source heating elements. More specifically, the light source heating elements can emit infrared light to cook the food.

In a third specific example, the appliance can use a heat source with minimal or no controllability (e.g., charcoal). However, the appliance can include any other suitable heat source.

The appliance can define a cooking cavity (e.g., cooking chamber, cooking volume, cooking cavity, etc.) that can receive food, accessories (e.g., plate, pan, baking sheet, pot, etc.), and/or other items. The cavity can include one or more racks for positioning the food and/or accessories in the cavity. The cavity can be accessible using the appliance door (e.g., side door, top door, etc.) or otherwise accessed. The cavity can be open, closed (e.g., reversibly sealed by the sealing component), partially open, or otherwise configured. The cavity can be lit, unlit, or have other visual properties. The cavity can include or be associated with one or more fiducials, which can be used to determine a sensor pose relative to the cavity. The fiducials are preferably statically arranged relative to the cavity (e.g., stamped, cast, stuck onto, or otherwise mounted to the cavity housing) with a known pose, position, and/or orientation, but can alternatively be movably mounted to the cavity. The fiducials can include: visual fiducials (e.g., asymmetric icons, stickers, stamps, bezels, or other features, etc.), wireless fiducials (e.g., Bluetooth beacons asymmetrically mounted to the cavity or housing, wherein the sensor pose can be determined via triangulation or trilateration), and/or other fiducials.

The appliance can include memory (e.g., non-volatile, volatile, etc.) that can store one or more states, residence time (e.g., for the period between food insertion and removal, for a food instance's cooking period, etc.), cooking instructions (e.g., cook time), and/or other information. The appliance can include a processor for sampling and recording cavity measurements, a communication system for receiving and/or transmitting information (e.g., to and/or from the remote computing system, to and/or from a user device, etc.), a clock to track residence time (e.g., a time associated with a food instance cooking within the cooking cavity), a display, and/or any other suitable elements. The appliance can be configured to receive user inputs (e.g., from a user device, from a touch screen on the appliance, from buttons on the appliance, etc.). However, the appliance can include other components.

Examples of appliances include: ovens, toasters, slow cookers, air fryers, warming drawers, broilers, cooktops, grills, smokers, dehydrators, and/or any other suitable appliance. A specific example of an appliance is described in U.S. application Ser. No. 16/793,309 filed 18 Feb. 2020, which is incorporated herein in its entirety by this reference. However, other appliances can be used.

The system can include one or more sensors for determining measurements (e.g., inference or training). The sensors are preferably integrated into the appliance, but can additionally or alternatively be separate from the appliance. The one or more sensors can include one or more: camera sensors, motion sensors, IMU sensors, depth sensors (e.g., projected light, time of flight, radar, etc.), temperature sensors, audio sensors, door open/close sensors, weight sensors, power sensors (e.g., Hall effect sensors), proximity sensors, microphones, and/or any other suitable sensor. The sensors can be directly or indirectly coupled to the cavity. The sensors can be connected to and controlled by the processor of the appliance, a user device, or be otherwise controlled. The sensors are preferably individually indexed and individually controlled, but can alternatively be controlled together with other like sensors. In a first example, the sensors can be mounted to the cooking cavity. In a second example, the sensors can be those of a user device (e.g., smartphone, tablet, smartwatch, etc.). However, any other suitable set of sensors can be used.

The one or more camera sensors can include CCD cameras, CMOS cameras, wide-angle, infrared cameras, stereo cameras, video cameras, smartphone cameras, and/or any other suitable camera. The camera sensors can be used with one or more lights (e.g., LEDs, filament lamps, discharge lamps, fluorescent lamps, etc.), which can be positioned next to the cameras, within a predetermined distance from the camera system, and/or otherwise positioned relative to the camera system. The camera sensors can be externally or internally located relative to the cooking cavity. The camera sensors can be mounted to the cavity wall, wherein the camera lens is preferably flush with the cavity wall, but can alternatively be recessed or protrude from the cavity wall. The camera can be centered along the respective appliance surface, offset from the appliance surface center, or be arranged in any other suitable position. The camera can be statically mounted to the appliance surface, actuatably mounted to the appliance surface (e.g., rotate about a rotational axis, slide along a sliding axis, etc.), or be otherwise coupled to the appliance. Alternatively, the camera can be separate from the appliance (e.g., on a smartphone, connected to secondary appliance, etc.). However, the sensors can include any other suitable components.

The system can include a processing system (e.g., processor) that can be local to the appliance and/or remote from the appliance and/or local to a secondary device and/or remote from the secondary device. The processing system can be distributed and/or not distributed. The processing system can be configured to execute the method (or a subset thereof); different processors can execute one or more modules (e.g., one or more algorithms, search techniques, etc.); and/or be otherwise configured. The processing system can include one or more non-volatile computing elements (e.g., processors, memory, etc.), one or more non-volatile computing elements, and/or any other suitable computing elements.

The processing system can include one or more modules, which can include one or more: classification modules, residence tracking modules, food instance matching modules, transition event modules, and/or any other suitable module. The modules can function to determine: a food classification (e.g., type, class, identity, ID, subclassification, state, etc.), cavity state (e.g., cavity occupancy state, such as empty or full), food presence, cook state (e.g., cooked, uncooked, degrees of cooked, etc.), food count, a cavity occupancy region, camera state, accessory type, foodstuff quantity, event occurrence (e.g., transition event occurrence), event classifier (e.g., transition event identity, such as insertion or removal), whether an unknown food instance is the same as a prior food instance, and/or any other suitable parameter. The modules can additionally or alternatively determine the uncertainty, confidence score, and/or other auxiliary metric associated with the each value (e.g., each classification, each output head, etc.).

One or more of the modules can include (e.g., leverage): neural networks (e.g., CNN, DNN, region proposal networks, single shot multibox detector, YOLO, RefineDet, Retina-Net, deformable convolutional networks, etc.), cascade of neural networks, logistic regression, Naive Bayes, k-nearest neighbors, decision trees (e.g., based on features extracted from a food instance image), support vector machines, random forests, gradient boosting, rules, heuristics, and/or any other suitable methodology. The modules can be submodules of a single module, or be separate modules. One or more of the modules can be generic, specific to a food class, specific to an appliance instance, specific to a user, and/or otherwise specialized.

The classification module functions to determine the food class of one or more foods within the cook cavity, and can optionally determine the cavity occupancy state, the food instance, and/or other parameters. The classification module can include multiple classifiers, a single classifier, and/or any other suitable number of classifiers. Each classifier can be a multi-class classifier, binary classifier, and/or any other suitable classifier. The classifiers can be trained on food instance images within a cooking cavity, or otherwise trained. The classifiers are preferably provided measurements (e.g., images) sampled by the system sensors, but can additionally or alternatively be provided features extracted from said measurements, derivative data from said measurements, auxiliary data, and/or any other suitable information. The classifier is preferably generic, but can alternatively be specific to a given food class.

However, the classification module can additionally or alternatively include any other suitable elements.

In a first variant, the system includes a single classifier, configured to determine a probability for each of a plurality of food classes, cavity states, foodstuff locations, foodstuff quantities, food doneness, cook state, and/or other parameter values. In a second variant, the system includes a different classifier (e.g., binary classifier) for each potential class value (e.g., each food class, each cavity state, etc.). In a third variant, different parameters have different classifiers (e.g., the system includes a classifier for food classification, a separate classifier for cavity state, a separate classifier for food doneness, etc.). In a fourth variant, the system includes a combination of the above. For example, the system can include a classifier (e.g., multiclass classifier) that determines the food class and optionally the cavity occupancy state (e.g., “empty”, “occupied”), and can include one or more separate classifiers (e.g., binary classifiers, multiclass classifiers, etc.), trained to classify the doneness (e.g., “cooked,” “uncooked”) or other aspect (e.g., browning) of specific food classes (e.g., timer-based cooking food classes). However, the system can include any other suitable classifier, configured in any other suitable manner.

The residence tracking module functions to track the elapsed time between food insertion into the cavity and food removal from the cavity. The residence tracking module can optionally track the total (e.g., aggregate) time a given food instance (e.g., individual piece of food) was cooked (e.g., across reinsertion events). The residence tracking module is preferably a counter or stopwatch, but can alternatively be a neural network (e.g., configured to predict or determine the total residence time) or otherwise configured. The residence tracking module can start tracking the residence time at insertion and add the tracked time to the previously elapsed time for the same food instance (e.g., from one or more prior cooking subsessions), can aggregate all residence times for all cooking subsessions for a given food instance, can retrieve the prior residence time for the food instance and begin tracking from the retrieved time, can store an initial insertion time (e.g., wall clock time) for a food instance, and/or otherwise track the aggregate residence time for the food instance.

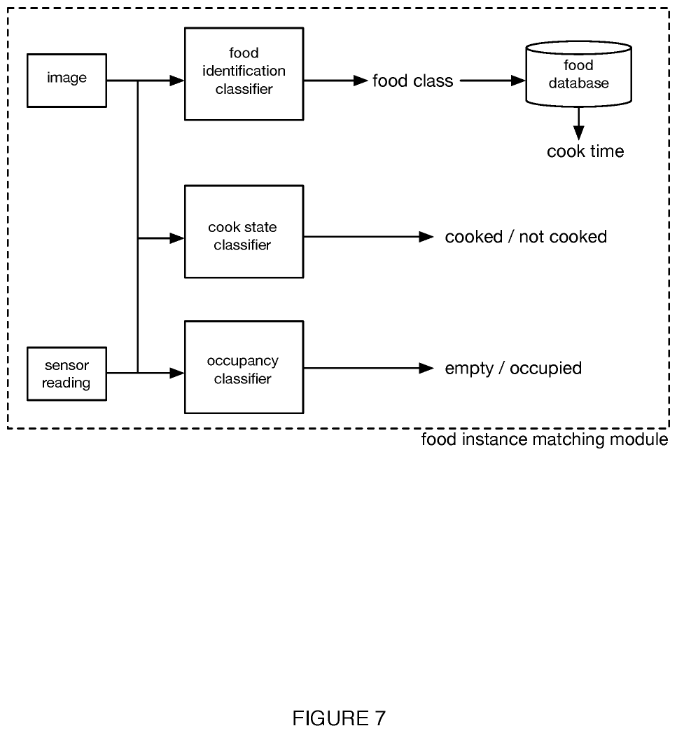

The food instance matching module functions to determine whether an unknown food instance is the same as a prior food instance or is different of food (e.g., whether the food currently in the cook cavity is a reinserted piece of food or a new piece of food). The food instance matching module can be: a classifier, a set of heuristics, and/or any other suitable module. In a first variant, the food instance matching module is a classifier configured to classify whether the food instance is the “same” or “different” from a prior food instance, based on a pre-removal measurement of the prior food instance and a post-insertion measurement of the unknown food instance. In a second variant, the food instance matching module is a set of heuristics. For example, the food instance is considered a reinsertion when the food classes match, the cavity was empty between prior food removal and unknown food (current food) insertion, and when both the prior food and unknown food are classified as “cooked” (e.g., by a classifier specific to the food class); example shown in FIG. 7. In another example, the food instance is considered a reinsertion when the food classes match and the unknown food's weight is substantially equal to or greater than the prior food's weight. In a third variant, the food instance matching module extracts features from measurements (e.g., images) of the prior food and unknown food, and determines that the food is a reinsertion when the feature vectors substantially match (e.g., are within a predetermined vector distance of each other; are statistically within the same vector cluster; etc.). However, the food instance matching module can be otherwise configured.

The food instance matching module can optionally determine a physical transformation of the food instance (e.g., after reinsertion). Physical transformations can include: translations, rotations (e.g., in the x/y plane, flips, etc.), addition of food material, removal of food material, and/or any other suitable transformation. In a first variation, the transformation is determined using a classifier (e.g., configured to classify the type of transformation applied to the food instance). In a second variation, the transformation is manually determined. In a third variation, the transformation is determined from the matrix transformation or the image transformation required to obtain matching feature vectors. However, the transformation can be otherwise determined.

The transition event module can function to determine or infer whether a transition event (e.g., food actuation event) has occurred and/or distinguish between transition events. A transition event can be indicative of or associated with a cavity state transition, such as: removal of a food instance, partial removal of a food instance, re-insertion of a previous food instance, insertion of a new food instance, an empty state detected between two occupied cavity states (e.g., empty cavity image detected between two images depicting food within the cavity), an empty state detected after an occupied state (or vice versa), a change in the cook temperature of the cooking cavity, a user checking on the food (e.g., a user input confirming the check has occurred, inferring the check has occurred based on the user turning on a light to illuminate the cooking cavity and/or pressing any touch screen, dial, or button on the appliance or secondary device, etc.), and/or any other event. Additionally or alternatively, the transition event can be indicative of or associated with a food alteration event, such as: food instance re-orientation (e.g., rotating, flipping, or otherwise moving the item within the appliance cooking cavity), food instance relocation (e.g., moving to a different zone), food instance modification (e.g., adding additional toppings, removing food from the food instance), a change in the cook state of a food instance, and/or any other event. In a first variant, the transition event module is a sensor, such as a door sensor, wherein the transition event is determined when the sensor samples a given state (e.g., a door open state) or predetermined pattern of states (e.g., door open state followed by a door closed state). In a second variant, the transition event module can include one or more rulesets or sets of heuristics (e.g., wherein the occurrence of and/or identity of the transition event can be inferred). For example, the transition event module can determine a food insertion event when the cavity is empty before door opening and the cavity is occupied after door closing. In another example, the transition event module can determine a food removal event when the cavity is occupied before door opening and the cavity is empty after door closing. However, the transition module can be otherwise configured.

The system can include a secondary device associated with a notification module, which can function to determine and/or send notifications to the appliance and/or a user device. The secondary device can be part of or associated with a user device. Alternatively, the notification module can be part of or associated with the appliance. The notification can be determined using rulesets, heuristics, querying a database using the match result, and/or otherwise determining the notification. However, the notification module can be otherwise determined.

The system can include one or more datastores, which can include training data for training the one or more classifiers, food class to cook time and/or cook temperature mappings (e.g., lookup table, lists, etc.), and/or any other suitable information. However, the datastore can additionally or alternatively include any other suitable components and/or elements.

The system can be used with one or more predetermined cavity occupancy regions (e.g., zones), locations, etc.). The zone classifier can function to determine or infer the zone within the cavity occupied or previously occupied by a given food instance. The zones (e.g., zone segments, zone delineators, zone identifiers, etc.) can be fed as input into the zone classifier, and/or otherwise used to determine the occupied regions. The zones can be defined relative to the cavity (e.g., in the cavity frame of reference, in the cavity coordinate system, relative to a cavity reference point, etc.), relative to the camera (e.g., relative to the camera's field of view, within the image frame of reference, within the image's coordinate system, etc.), be defined based on an accessory (e.g., relative to a reference on the accessory), heating element arrangement, and/or otherwise defined relative to another frame of reference. The predetermined zones can cooperatively cover (e.g., encompass) the entire frame of reference (e.g., entire image, entire cavity, entire accessory, etc.), a portion of the frame of reference (e.g., less than 99%, 90%, 80%, 60%, 50%, etc. of the image, cavity, accessory, or other reference, etc.), and/or any other suitable portion of the frame of reference.

The system can be used with one or more instruction elements, which can include: recipes, cook programs, cook primitives, operation instructions, preheat instructions, target parameters (e.g., target temperature, target power output, target cook time, etc.), cook instructions, and/or any other suitable instruction elements. The instruction elements can be specific to an appliance type or class, or globally applicable. The instruction elements can be specific to a group of heating elements (e.g., specific heating element identifiers, relative heating element arrangement, number of heating elements, etc.), all heating elements, any heating element, no heating elements, and/or any other arrangement of heating elements. The target parameters can be determined based on a food classification, a cavity temperature, a user input, or based on any other parameter or model. Examples of the cook primitives include preheat, bake, broil, roast, fry, dehydrate, and/or any other suitable cook primitive. The operation instructions can be machine instructions, user input instructions, and/or any other suitable instructions.

All or part of the instruction elements can be predefined, user selected, static, dynamic, and/or otherwise determined. The instruction elements can apply to a cook session (continuous appliance operation; continuous period where the cavity temperature is at a cooking temperature or controlled based on a single cooking instruction set; or otherwise defined) and/or a cook subsession (period between transition events; aggregate residence time for a given food instance; aggregate residence time for a food instance at a given temperature, cook session, or otherwise defined). Any cook session can be a cook subsession or vice versa. In a first example, the instructions are automatically learned, refined, or otherwise updated from one or more prior cook sessions. In a second example, the instructions are automatically learned, refined, or otherwise updated based on a prior cook subsession (e.g., for a single food instance within the same cooking session). In a third example, all or part of the instruction elements are automatically adjusted (e.g., adjusted based on visual and/or temperature cues as the food cooks and/or based on the food classification). Alternatively, all or part of the instruction elements are not dynamically and/or automatically adjusted.

Each instruction element can be associated with a predetermined food classification (e.g., represents a single food classification, multiple food classification, etc.) and/or a predetermined cavity temperature (e.g., cooking temperature). Each instruction element can be associated with one or more predefined versions that represent a modified instruction based on one or more occupied zones (e.g., per heating element associated with the occupied zone(s)). The predefined versions can be defined based on food parameter value combinations (e.g., classification(s), zone(s), count(s), quantity, accessory, etc.) or otherwise determined.

Different food classes can be associated with different instruction elements. For example, some food classes can be associated with a temperature schedule (e.g., a target cavity temperature, a timeseries of target cavity temperatures, etc.) and/or an automatic termination condition (e.g., target food temperature, target cook time, etc.) where food cooking can be automatically terminated (e.g., by shutting the heating elements off) when the termination condition is met. Other food classes can be associated with a facilitated termination condition (e.g., target cook time), wherein food cooking is not automatically terminated through appliance or heating element control, but is rather terminated through other (indirect) means, such as by instructing a user to remove the food, automatically removing the food from the cook cavity (e.g., using a conveyor), or otherwise terminated. Yet other food classes can be unassociated with heating element control instructions or target temperature schedules. The appliance can automatically determine which control schema to use based on the detected food class, based on a user instruction, or otherwise determine how to control heating element operation.

However, the instruction elements can additionally or alternatively include any other suitable elements.

However, the system can additionally or alternatively include and/or be used with any other suitable components and/or elements.

### 5. Method

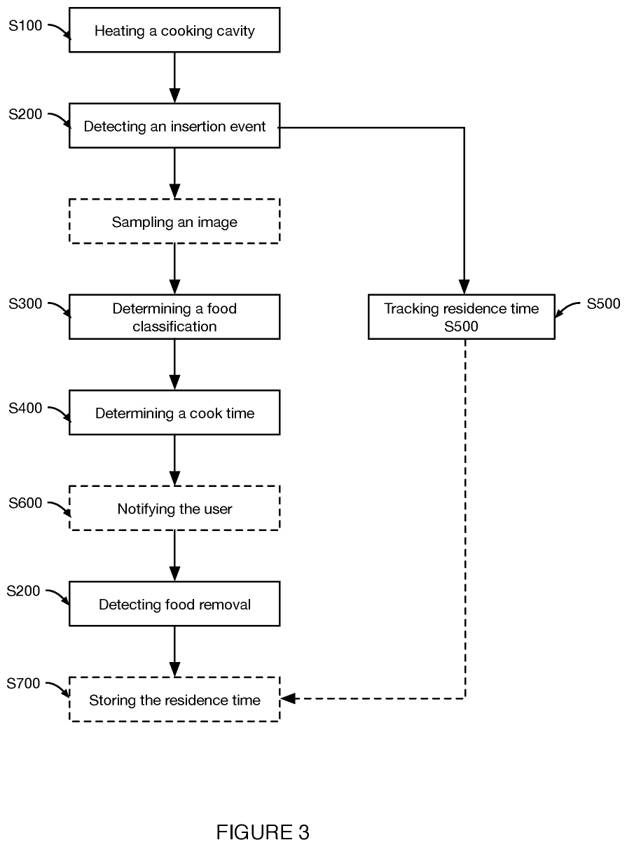

The method for intelligent, timer-based cooking can include: heating a cooking cavity to a cooking temperature S100, detecting an transition event S200, determining a food classification S300, determining a cooking time S400, tracking a food residence time within the cooking cavity S500, optionally notifying a user when the residence time satisfies the cooking time S600, and/or any other suitable steps. One embodiment includes storing the residence time S700 in response to a removal event detection S200, as shown in FIG. 3. The method is preferably performed using the system above, but alternatively can be performed with any other system.

All or portions of the method can be performed in real- or near-real time, or asynchronously with image acquisition and/or one or more cook sessions. All or portions of the method can be performed at the edge (e.g., by the appliance, by a user device connected to the appliance, etc.) and/or at the remote computing system. All or portions of the method can be performed automatically, manually, or otherwise performed.

The method can be performed after a predetermined event (e.g., door open, door close, door open and door close), after receiving user input (e.g., cook instruction), after receiving a user device instruction (e.g., based on the cook program), periodically, and/or at any other suitable time. One or more steps of the method can be performed one or more times for a single food instance, for different food instances, for a single cook session or subsession, and/or for different cook sessions or subsessions.

Heating a cooking cavity S100 can function to provide a heated cooking environment. S100 can function to: heat the cavity to a predetermined temperature, maintain the cooking cavity at a target cooking temperature, uncontrollably heat the cavity, heat the cooking cavity according to control instructions (e.g., related or unrelated to the food class), or otherwise heat the cavity. Preferably, the heating elements within the cooking cavity are associated with a set of control instructions which are not dynamically adjusted to achieve a different cooking temperature during food instance residency within the cooking cavity. Alternatively, the control instructions can be dynamically adjusted.

The cooking temperature can be associated with the food class of the food (e.g., determined in S300), be unrelated to the food class of the food, and/or be otherwise determined. The cooking temperature can be user selected, or automatically selected (e.g., based on a previous cook session or subsession, the food classification, etc.), and/or uncontrolled.

S100 can be performed: before, during, after, and/or throughout one or more instances of food cooking (e.g., throughout one or more instances of any of S200-S700). In a first variant, heating occurs when a user operates the appliance (e.g., lights grill, lights charcoal, selects preheat setting on the appliance or user device, etc.). In a second variant, the cooking temperature is manually selected or input. In a third variant, the cooking temperature is selected based on a food class or recipe (e.g., automatically or manually selected). In this variant, the cooking temperature is not selected based on an image of the food instance in the cooking cavity and/or the classification determined by the image.

S100 can occur in one stage or in multiple stages. In one variant, the cooking elements can be operated to achieve a target cavity temperature (e.g., operated at high or maximum power output) during a first stage, then selectively operated to substantially maintain the cavity at the target cavity temperature (e.g., using closed-loop control, etc.). For example, the set of heating elements can be controlled using a temperature-based PID loop (e.g., iteratively sampling cavity temperature measurements to determine the difference between the cooking cavity temperature and the target cooking temperature, then selectively turning heating elements on/off to achieve the target cooking temperature, etc.) in the second stage. Alternatively, the operation instructions can be dynamically adjusted (e.g., based on images sampled of a food instance within the cooking cavity, temperature sensors measuring temperature on or within a food instance, the classification module etc.), adjusted based on user input (e.g., to change the target cooking temperature), or otherwise managed.

In one variant, the instruction elements can include a preset recipe or operation instructions with one or more cooking stages (e.g., subsessions), each associated with a different target cavity temperature, cook time, and/or other cook parameters. In embodiments, these operation instructions can be independent of the food class and/or other food parameters (e.g., current internal temperature), or dependent on the food parameters. The method can facilitate cooking termination (e.g., via user notification, food actuation, etc.) between cooking stages, or not facilitate cooking termination between cooking stages.

In a second variant, a first subsession for a food instance undergoes cooking via dynamic temperature control, followed by a second subsession for the same or a different food instance which undergoes static temperature cooking. In one example where the final temperature of the first subsession is the same temperature as the static temperature of the second subsession, no preheating occurs between the two subsessions.

In a third variant, the set of heating elements can be controlled based on a set of control instructions (e.g., directing power output, including multiple heating stages, power output based on cavity temperature and/or target cook temperature, etc.). The control instructions can be additionally based on: the target cook time (e.g., in relation to the residence time), transition event detection, user input, and/or any other event.

In a fourth variant, S100 includes modifying the heating instructions when food is detected within the cooking cavity (e.g., the transition event module indicates likely food presence within the cavity). In one embodiment, S100 can include notifying the user and/or prompting the user for a user input to modify the heating instructions (i.e. continue heating, preheat at low/high/adjusted power, stop heating, continue heating after food removal, etc.). In another embodiment, heating occurs with adjusted heating element instructions (e.g., to avoid burning the food within the cavity while preheating) such as: operating in a lower power mode, adjusting the power for a subset of the heating elements based on the zone of the heating elements and/or the location of the food instance within the food cavity, and/or any other adjustment.

In a fifth variant, heating is uncontrolled and/or the cooking cavity is heated to an undefined cooking temperature.

However, S100 can be otherwise performed.

Detecting a transition event S200 can function to determine the start, pause, end, reset, and/or restart time for residence time tracking and/or can function to determine whether to update the target cook time and/or residence time. Alternatively or additionally, detecting a transition event can function to distinguish between transition events. S200 can be performed with the transition event module in association with one or more sensors. S200 can additionally or alternatively be performed with the classification module and/or the food instance matching module. However, it can be otherwise performed (e.g., with any other classifier, module, sensors, system, etc.).

The transition event can be detected after S100, S500, and/or S600, concurrently with S100, S500, and/or S600, before S100, S500, and/or S600, and/or at any other suitable time. S200 can trigger determining a food classification S300 (e.g. S300 occurs in response to S200). Additionally or alternatively, S200 can trigger the start or end of tracking a food residence time S500. Additionally or alternatively, S200 can function as a trigger and/or endpoint for any other step. S200 can re-occur multiple times during a single cook session and/or subsession.

The transition event can additionally or alternatively be associated with an initial transition time, any other transition or cook time, and/or any other suitable time. In the case of an initial insertion event (e.g., insertion of a new, uncooked food instance), the event can be associated with an initial insertion time. In the case of a re-insertion event of a previous food instance, the re-insertion event can be associated with a re-insertion time as well as an initial insertion time of the food instance and/or a first removal time of the food instance (e.g., prior to re-insertion).

In one variant, a transition event is determined or inferred based on the current cavity/appliance state and/or one or more sensors. In one embodiment, when a food instance is present in the food cavity, a door sensor registers door opening, which indicates the removal of a food instance from the food cavity. In another embodiment, when a food instance is present in the food cavity, a camera mounted to the door registers door opening, which then indicates the insertion of a food instance. In another embodiment, a change in the weight sensed by a weight sensor in the food cavity (e.g., where the absolute value of the change is greater than a predetermined threshold) indicates a food instance insertion (e.g., weight increase) or removal (e.g., weight decrease). In another embodiment, the event of a user checking on a food instance is determined or inferred based on the user turning on a light to illuminate the cooking cavity and/or pressing any touch screen, dial, or button on the appliance or secondary device.

In a second variant, the transition event is determined or inferred based on a timeseries of cavity images. For example, a series of cavity images depicting an occupied cavity, then an empty cavity, can be associated with a food removal event, while a series of cavity images depicting an empty cavity then an occupied cavity can be associated with a food insertion event. In some embodiments, this variant can include S250.

In a third variant, the transition event is detected based on the time relative to a target cook time and/or relative to a notification sent to the user. In one example, when a notification is sent to the user that the residence time has satisfied the target cook time, a door open event indicates a food removal event and/or a user turning on the appliance light indicates that the user has checked on the food instance and determined that cooking will resume. In another example, when a notification is sent to the user that they should relocate or re-orient (e.g., flip) or otherwise alter a food item, a door open event indicates that the user has successfully completed the recipe step.

In a fourth variant, the transition event can be reinterpreted or redetermined based on a subsequent transition event or measurement. In one example, if the transition event is a food instance removal, a subsequent insertion event of an uncooked food instance and/or a food instance of a different classification confirms that the removal was a final removal (e.g., no re-insertion). In another example, if a transition event (e.g., food instance removal) is inferred by one or more sensors (e.g., a door open/close sensor), a subsequent measurement (e.g., weight sensed in the cooking cavity, image of the cavity indicating food presence) can update/correct the transition event classification.

In a fifth variant, the transition event is detected based on a user input. In one example, the user confirms/denies a prompt indicating a proposed transition event (e.g., “pizza removed? Yes/No”). In another example, the user selects or inputs the transition event (e.g., “burger flipped on grill”, “toppings added”, “checked on bake, needs more time”, etc.). In another example, the user can confirm that a removal event is a final removal event. This user input can be implemented instead of or in addition to the previous variants.

However, S200 can be otherwise performed.

Determining a food classification S300 can function to determine the classification of a food instance inserted into the cavity for cooking time determination in S400.

The food classification can be associated with cooking instructions (e.g., an optimal/target cooking temperature, an optimal/target cooking time, a mapping of cooking temperatures to cooking times, etc.). The food classification can additionally or alternatively be associated with a confidence score (e.g., value between 0-1, value between 0-100, etc.), and/or associated with any other information. In a first example, the classification with the highest confidence score (e.g., absolute highest; highest by more than a threshold value; etc.) is considered as the food class. In a second example, multiple classifications are outputted (e.g., the classifications with the highest confidence scores); the user can then select a classification from the outputted classifications. In a third example, the classification is selected independent of a confidence score.

The food classification can be determined after S200, in response to S200 (e.g., after detecting a change in cooking cavity occupation from empty to occupied), concurrently with S200, before S200, and/or at any other suitable time. The food classification can be determined from one or more images sampled of the food instance within the food cavity (e.g., by one or more in-situ camera(s), a user device, etc.). The classification can then be determined based on features extracted from the image(s). The features can be extracted from a segment of the image. Alternatively, the food classification can be determined from any other suitable image. Additionally or alternatively, the food classification can be determined based on a user input. Determining the one or more food types can be performed within a predetermined time after sampling the measurements, processing the measurements, and/or detecting a transition event (e.g., less than 5 ms, less than toms, less than 20 ms, less than 25 ms, less than 30 ms, less than 50 ms, between 10-30 ms, between 15-25 ms, etc.), and/or performed at any other suitable time.

In a first variant, the one or more food classifications can be determined using one or more modules. Preferably, the food classification is determined using the food classification module, but alternatively any other module, classifier or combination of modules and/or classifiers can be used. The module can be used to determine one or more food classifications depicted in an input image of a food instance within the cooking cavity (e.g., image, segment, etc.), food classification per occupied zone, food classification per image segment, and/or any other suitable output. The module can ingest one or more measurements, foodstuff image segments, foodstuff masks, user input (e.g., to confirm or select one or more proposed classifications), and/or any other suitable information.

In a second variant, the one or more food classifications can be determined based on user food classification selection. In an example, the user is prompted to select a classification from a list of proposed classifications based on the classification probabilities, previous classifications used, the cooking temperature, and/or any other suitable information. In another example, the user manually inputs and/or selects the classification.

However, the food classification can be determined using any of the methods disclosed in: U.S. application Ser. No. 16/793,309 filed 18 Feb. 2020, U.S. application Ser. No. 16/380,894 filed 10 Apr. 2019, U.S. application Ser. No. 17/311,663 filed 18 Dec. 2020, U.S. application Ser. No. 17/345,125 filed 11 Jun. 2021, U.S. application Ser. No. 17/245,778 filed 30-Apr.-2021, U.S. application Ser. No. 17/201,953 filed 15 Mar. 2021, U.S. application Ser. No. 17/216,036 filed 29 Mar. 2021, U.S. application Ser. No. 17/365,880 filed 1 Jul. 2021, U.S. application Ser. No. 17/376,535 filed 15 Jul. 2021, and/or application Ser. No. 17/403,472 filed 16 Aug. 2021, each of which are incorporated herein in their entireties by this reference.

However, the food classification can be otherwise determined.

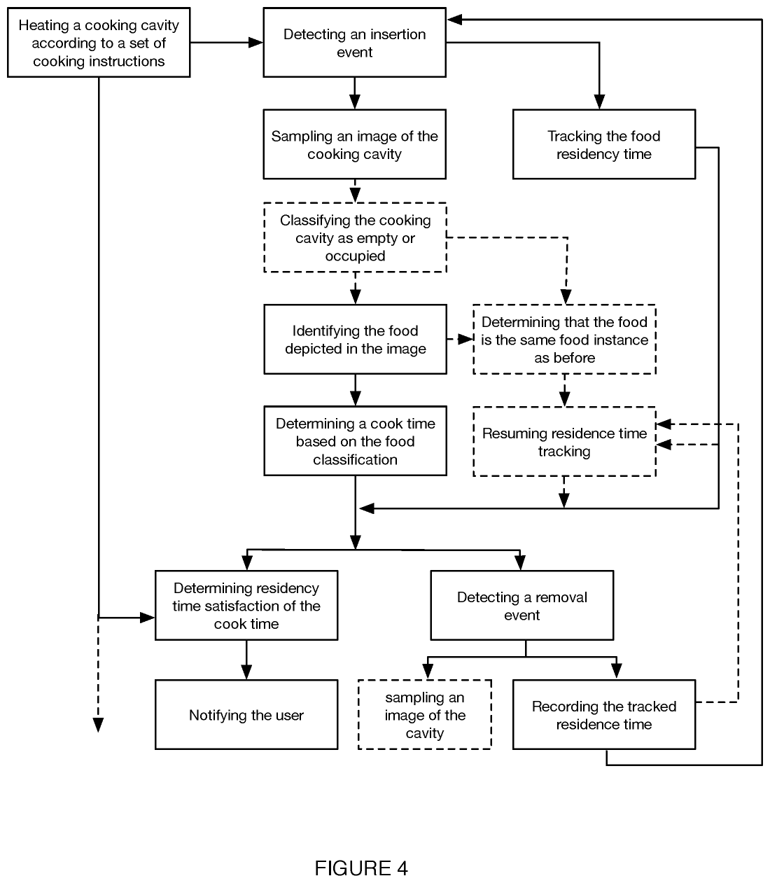

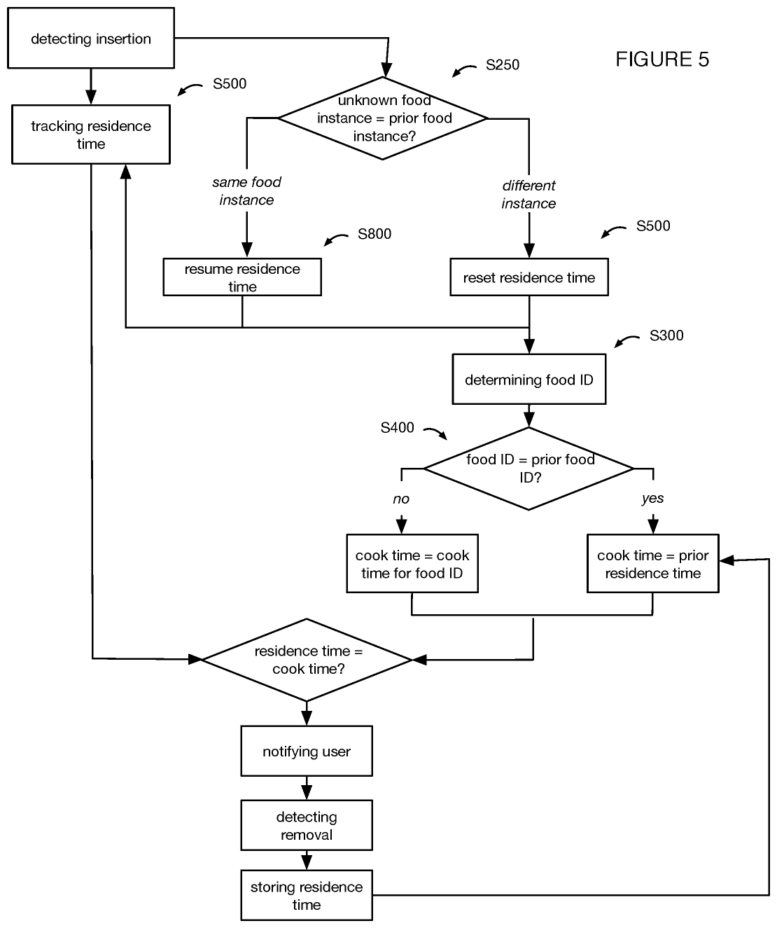

The method can optionally include determining whether a food instance is equivalent to a prior food instance S250 (e.g., distinguishing between insertion of a new food and re-insertion of a prior food instance); example shown in FIG. 4. The reinsertion determination can be used to determine whether a prior residence time tracking should be resumed S800 (e.g., determine the aggregate residence time for the food instance, adding time to the prior residence time, retrieve the starting timestamp, etc.), or determine whether a new residence time tracker should be started S500; example shown in FIG. 5. However, the reinsertion determination can be otherwise used.

S250 can be performed during S200, S300, and/or at any other suitable time. S250 can be performed by the food instance matching module, or by any other suitable module.

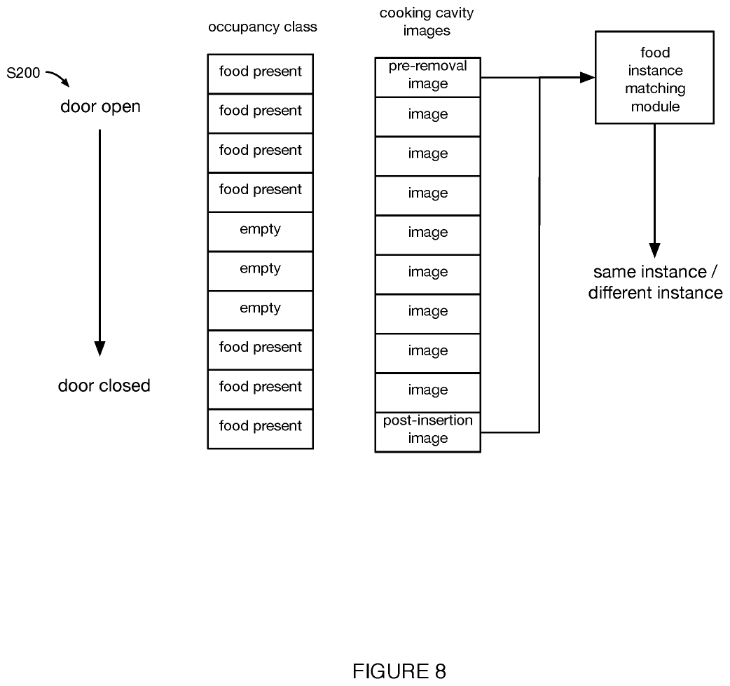

Reinsertion can be determined based on one or more pre-removal measurements of a first food instance and one or more re-insertion measurements of an unknown food instance (e.g., second food instance, new food instance, current food instance, etc.), example shown in FIG. 8. The pre-removal measurement can be a first image (e.g., most recent image of a food instance prior to removal detection, image of food instance taken in response to a door open event, etc.) and the re-insertion measurement can be a current image of an unknown food instance within the cooking cavity. Alternatively, the measurements can be any other measurements from the one or more sensors.

In one variant, S250 can include: extracting features from the pre-removal measurement and the re-insertion measurement, comparing the features, and classifying the first food instance and unknown food instance as the same food instance if the distance between measurements is less than a threshold distance. In an example, the comparison can be determining the distance between the feature vectors. In another example, the comparison can include classifying the food instance as the same instance when the confidence score and/or probability for the “same” class exceeds a threshold (e.g., is higher than the “different” class, is higher than a predetermined threshold, etc.). This comparison and classification can focus on specific regions of the food, wherein the region(s) can vary based on the food class (e.g., for food instances in the pizza class, the region is the crust/boundary rather than the center or vice versa). Alternatively, the entire food can be used for analysis (e.g., the entire image segment depicting the food).

In a second variant, S250 can use a heuristic method. The pre-removal measurement and re-insertion measurement can be compared and evaluated based on the food classification (e.g., using a different comparison technique dependent on the food classification). This can take into account re-orientation of a food instance and/or modifications to the food instance. In one example, a browning level parameter is used: if the unknown food instance has the same (and/or greater) level of browning it is classified as the same food instance as the first food instance; if the unknown food instance has a lesser level of browning by a threshold amount, it is classified as a different food instance. In another example, a steak is associated with a flip detection (e.g., based on a transition event S200, weight change—weight decrease during flip action, images, food surface temperature, etc.). If no flip is detected, then the unknown food instance is classified as the first food instance.

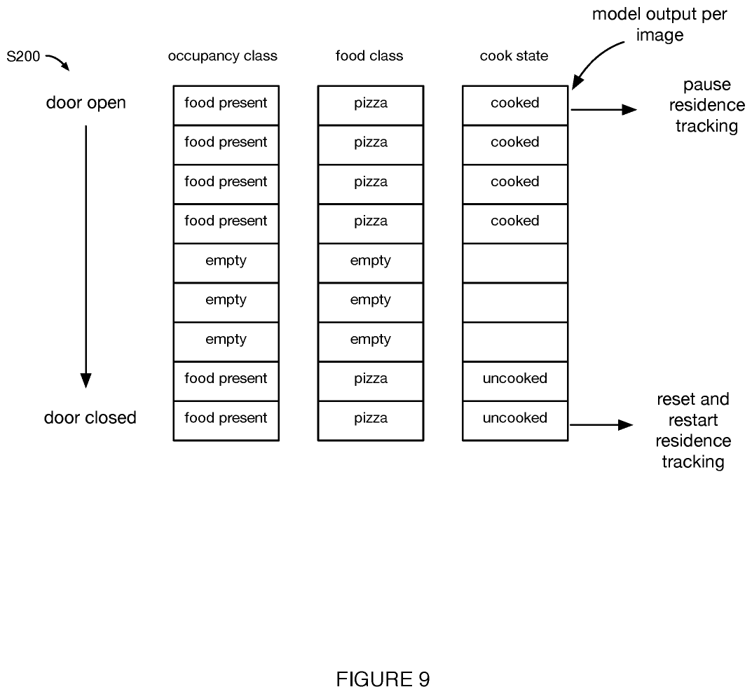

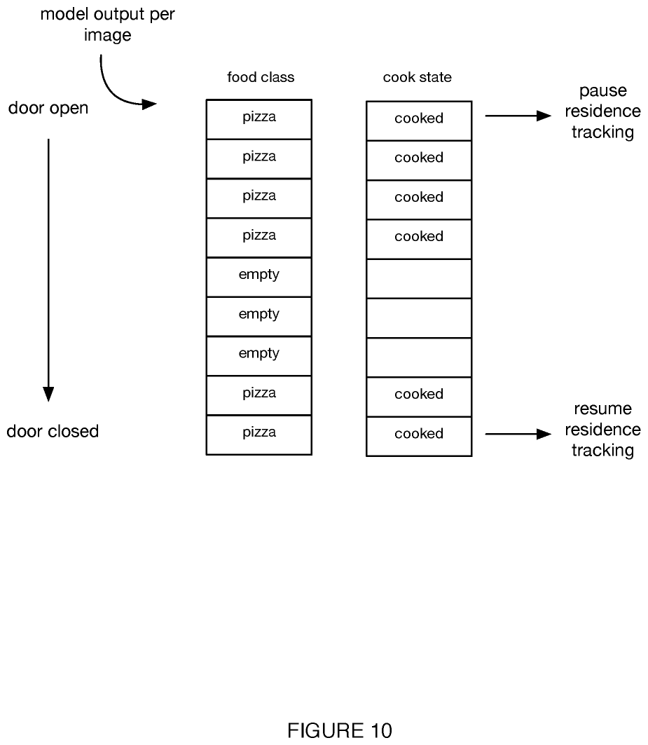

In a third variant, subclassification(s) of the first food instance and the unknown food instance are compared. In one example, the classification module classifies a cook state of the first food instance based on a pre-removal image of the first food instance and a cook state of the unknown food instance based on a post-insertion image of the unknown food instance. In a specific example, the pre-removal image depicts an uncooked food instance and the post-insertion image depicts a cooked food instance, indicating the unknown food instance is the same food instance as the first food instance. In another specific example, the pre-removal image depicts a cooked food instance and the post-insertion image depicts an uncooked food instance, indicating removal of the cooked food instance and insertion of a new food instance; example shown in FIG. 9. In another specific example, the pre-removal image depicts a cooked food instance and the post-insertion image depicts a cooked food instance, indicating re-insertion of the first food instance; example shown in FIG. 10. Additional food classifications/subclassifications of the first food instance and unknown food instance may additionally or alternatively be compared (e.g., if the unknown food instance and first food instance are different food classes, they would be determined to be different food instances).

In a fourth variant, the pre-removal measurement and re-insertion measurement are weights. If the unknown food instance weight is substantially equal to and/or above the first food instance weight, it is classified as the same instance.

In fifth variant, re-orientation and/or re-location transition events are used in determining or inferring whether the unknown food instance is the same food instance. In one example, the transition event is associated with a notification and/or a timing. In an illustrative example, if a notification was sent to a user to flip a food instance and the appliance door was opened, it can be inferred that the food instance was flipped and thus the unknown food instance (post-flip) is the same food instance. In another illustrative example, if the time until the target flip time is below a threshold and the door opens, it can be inferred that the food instance was flipped. In another example, a user input is used to determine the re-orientation and/or re-location transition event, which in turn determines whether the unknown instance is the same/different food instance. In another example, the classification module can be used to classify one or more cook states. If the food instance requires cooking in multiple stages (e.g., one side, then another), the transition from the first stage to the second stage can result in an uncooked state for the same food instance (e.g., the top of a steak should initially be uncooked, then transition to cooked after flipping). In another example, image transforms on the pre-removal and/or re-insertion image are used to determine the re-orientation/re-location.

In a sixth variant, a user input is used to determine whether the unknown food instance is the same instance as the first food instance. The user can specify whether the unknown food instance is the same and/or the user can confirm or deny the automatic reinsertion determination.

Alternatively, any combination of the one or more variants can be used.

Determining a cook time S400 can function to determine how long the food instance should be cooked for (e.g., target/optimal/ideal cook time, target/optimal/ideal residence time, etc.) and/or instructions for the food instance at the given cooking temperature. Alternatively, S400 functions to determine a check time (e.g., when the user should check on the food instance if the optimal cook time is uncertain). The cook time can apply to a cooking session and/or a cooking subsession (e.g., the first item in a batch bake, the first side of a food instance on a grill, the first step in a multistage bake, etc.). The cook time is preferably different from the residence time (e.g., is a target time instead of an incremented, tracked time), but can alternatively be the same.

The cook time can be determined after S300, in response to S300 (e.g., after determining one or more classifications of the food instance), concurrently with S300 (e.g., the classification includes the cook time), before S300, and/or at any other suitable time. S400 can be performed using the datastore (e.g., by determining a cook time for the one or more food classes at the cavity's current temperature), using the classification module (e.g., a food identification classifier and/or any other classifier), and/or using any other suitable element.

In one variant, the cook time is associated with the food classification(s) determined in S300. The cook time can be further associated with one or more food classifications for the food instance at a temperature near the cooking temperature set in S100. In an example, a given food instance can include multiple classifications/subclassifications which is then used to determine the cook time given the cooking temperature (e.g., the classifications/subclassifications are mapped to an optimal cooking temperature). In a specific example, the food classifications/subclassifications can include: food type, food size, food weight, food location, or any other food parameters, wherein different parameter values can be associated with different cook times.

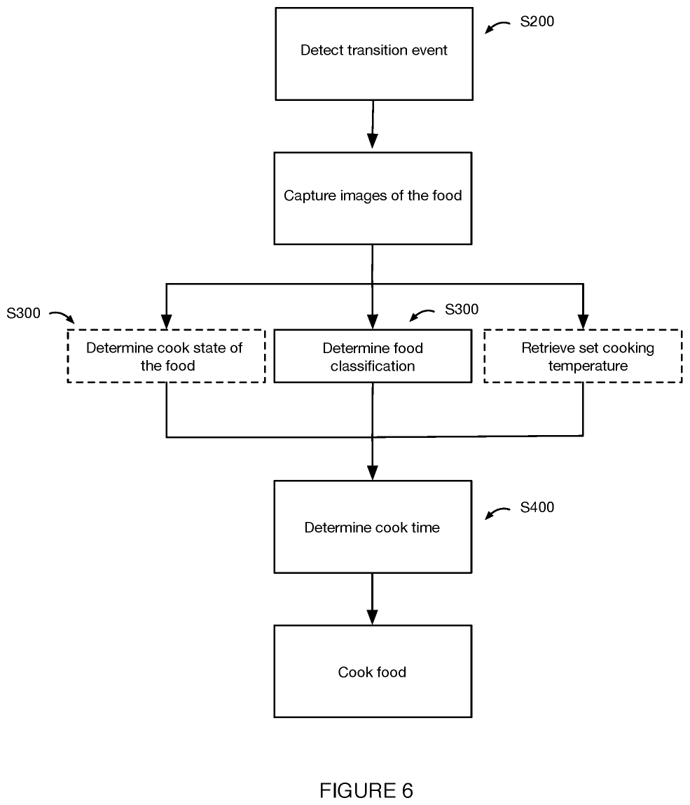

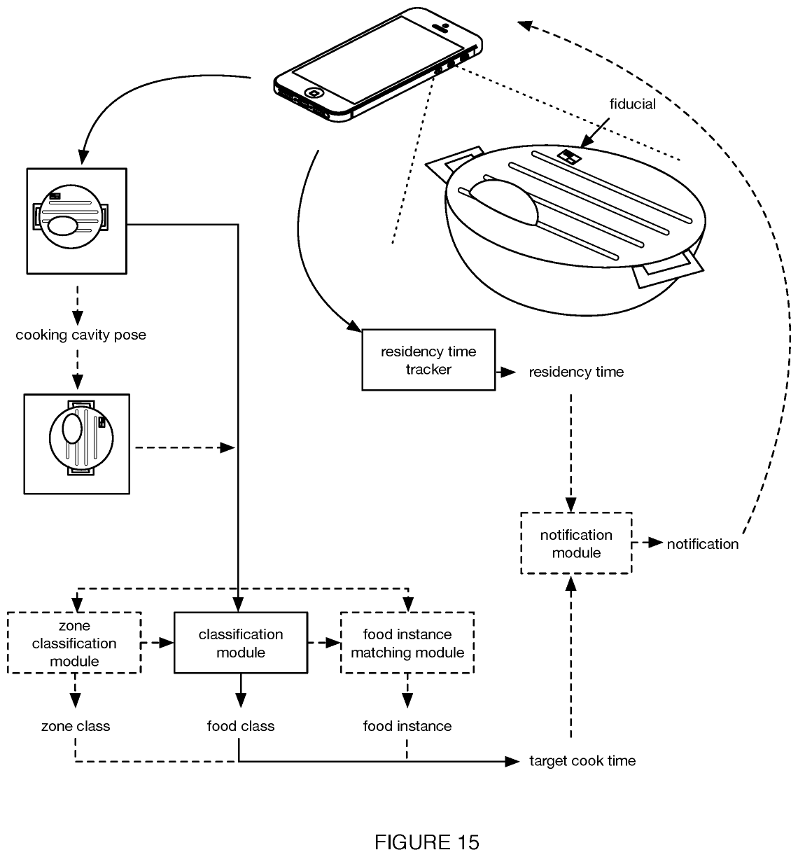

In a second variant, the cook time is calculated based on a relationship between cooking temperature and cook time for the given food classification. In an example, the food classification(s) is mapped to multiple cook times at multiple cooking temperatures (e.g., one cook time for each cooking temperature). The determined cook time can then be the cook time associated with a cooking temperature nearest to the set cooking temperature (e.g., example shown in FIG. 6). In another example, the cook time is calculated with a function, algorithm, and/or model correlating cooking temperature to cook time. In an illustrative example, a pizza of a specific size, weight, and/or type should cook for 20 min at 350° while that same pizza should cook for 30 min at 325°. This calculation can be additionally based on the location of the food instance within the cooking cavity (e.g., example shown in FIG. 15).

In a third variant, the cook time is determined via a user input. In one example, the user can override a determined cook time. In another example, the user can select a cook time from a list of suggested cook times. In another example, the user determines a check time and/or a time interval prior to the determined cook time to check on the food instance. However, the cook time can be selected via any suitable input method.

In a fourth variant, the cook time is retrieved from a prior cooking session/subsession (e.g., example shown in FIG. 5). This can function to reuse learned information and can be useful in batch cooking since the cooking environment/context tends to be similar (particularly when the operation instructions for the set of heating elements is maintained substantially constant/set). The cook time can be the cook time selected for a previous food instance of the same class (e.g., generic cook time for the food class, retrieved from the database), be the final residence time of a prior food instance of the same class (e.g., from a prior cooking subsession of the same cooking session; from a prior cooking session; etc.), and/or otherwise determined. This variant can be used for the same user/appliance (e.g., for a given user, using the cook time or residence time of a prior cooking session that user performed) or for a different user/appliance (e.g., using final residence time for a given food classification cooked on a different appliance). The cook time can be selected from a single previous cook sessions/subsession, averaged from prior cook sessions, or otherwise calculated from multiple previous cook sessions/subsession. The cook time determination can occur with or without determining that one or more food classifications of the current food instance matches one or more food classifications of the food instance in the prior session/subsession, and/or with or without determining that the cooking temperatures in the current and prior session/subsession are the same or within a predetermined range. In an example, the cook time is selected from one or more prior subsessions in a given cook session (e.g., the most recent subsession(s), the most recent subsession(s) for a given food classification, etc.) within the same cook session. Alternatively, the cook time can be selected from a different cook session. In another example, the cook time is selected from a prior session/subsession with user confirmation (e.g., user confirms the prior session/subsession was successful). In another example, the cook time is modified from a prior session/subsession (e.g., if the cooking temperatures are not within a predetermined range, the cook time is adjusted).

In a fifth variation, the cook time is a default time (e.g., independent of food class). For example, the cook time can be 30 seconds, 1 minute, 10 minutes, 20 minutes, and/or any other suitable amount of time. The default cook time can be determined based on: whether a transition event was detected, whether the food instance is the same food instance as before, and/or used when other conditions are satisfied. For example, the default cook time can be used when the food is reinserted and the food class' cook time is met (e.g., the residence time met or exceeded the cook time for the food class).

In a sixth variation, the cook time can be determined based on a target cook time and the residence time for the same food instance. This variant can be useful when the food is reinserted, and the target cook time has not been met. The cook time can be the difference between the target cook time (e.g., associated with the food class) and the residence time, be the difference adjusted with an amount of buffer time (e.g., to account for cavity and/or food cooling during the transition events), and/or otherwise determined.

However, the cook time can be otherwise determined.

The method can optionally include adjusting cook instructions based on the set cooking temperature S450. S450 can function to mitigate the effects of setting a nonoptimal cooking temperature for a given food classification. S450 can occur after S300, before S300, concurrently with S300, and/or at any other suitable time.

In a first variant, if the determined food classification S300 is associated with an optimal cooking temperature that is not the cooking temperature set in S100, the cooking temperature can be adjusted. In one example, the user is prompted to adjust the cooking temperature. In another example, the cooking temperature is automatically adjusted. In a second variant, the final residence time for a food instance inserted during or before S100 is adjusted or not used in S400 for subsequent cook sessions/subsessions and/or the final residence time is used for a future cook session when the future food instance is similarly inserted during or before heating.

However, the cook instructions can be otherwise adjusted or not adjusted.

Tracking a food residence time within the cooking cavity S500 can function to monitor the length of time a food instance has been cooking (e.g., residence time, time within the cavity, residency time) and/or to compare the residence time to the target cook time. Preferably, the residence time is tracked while the cooking cavity is being maintained at a substantially constant temperature (e.g., within a margin of control error). Alternatively, the residence time can be tracked while the cooking cavity is being uncontrollably heated, across multiple temperatures (e.g., across multiple cooking stages), and/or at any other suitable time.

S500 can occur after S200, in response to S200, after S300, after S400, and/or at any other time. The residence time can be the time between two transition events (e.g., starting at the insertion of a food instance and ending at a removal event), an aggregate cook time for the same food instance across one or more transition events, the time between an initial insertion timestamp and a current time, and/or otherwise defined. The residence time can be for the food instance in a single cooking stage (e.g., the first side of grilling, cooking at a constant temperature, etc.) and/or for the food instance across multiple cooking stages.

The residence time can be tracked with a clock on the appliance, in the cloud, on a user device (e.g., smartphone, tablet, etc.), and/or any other appliance or device. The timer can be physical or digital. The residence time can be tracked by setting a clock to count up (e.g., count up or aggregate time relative to an initial insertion time, a re-insertion time, and/or any other time; monotonically increasing; etc.), but can alternatively be tracked by counting down (e.g., monotonically decrease). Preferably, the residence time is based on the initial insertion time of the food instance; alternatively, the residence time can be based on an elapsed time (e.g., since a transition event occurred) and/or any other suitable reference time. In one example, the clock (and/or a display linked to the clock) shows the tracked residence time as well as the target cook time. In another example, the clock/display shows the residence time as well as the target cook time until the target time has been satisfied. In another example, the clock/display shows only the residence time. In another example, the clock/display shows the time counting down from the target cook time (e.g., while the residence time can still be tracked counting up).

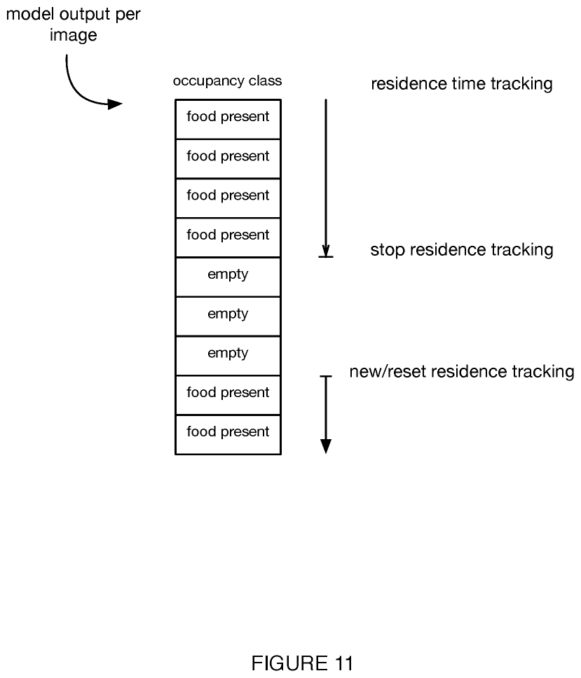

In one variant, tracking the residence time S500 occurs while the occupancy of the cooking cavity (and/or an accessory within the cooking cavity) is classified as occupied; example shown in FIG. 11.

In another variant, tracking the residence time S500 starts and/or resumes at an insertion event detection S200 or any other transition event detection. In a second variant, S500 starts when preheating S100 is finalized and/or when the cooking cavity reaches the cooking temperature. In a third variant, S500 starts and/or resumes based on a user input.

In another variant, tracking the residence time is stopped or paused after a transition event (e.g., door open/closed, removal event, and/or any other event). In one embodiment, the residence time is stopped after final removal is detected. In a second embodiment, the residence time is paused after a removal event and resumes after a reinsertion event (e.g., wherein the prior residence time is retrieved and used as the starting basis for residence time tracking); example shown in FIG. 10. Alternatively, a new timer can be started upon food instance reinsertion, wherein the newly tracked residence time is added to the prior residence time (for the same food instance) to obtain the overall residence time. In a third embodiment, the residence time is not paused during the period between removal and re-insertion for a food instance.

In another variant, multiple residence times are tracked during a multi-stage cook (e.g., one residence time for each stage). In an example, the residence time during cooking of the first side of a food instance is tracked, followed by a second residence time during cooking of a second side of the food instance. In another example, the tracked residence time is linked to the cooking cavity temperature (e.g., temperature measurements are linked to residence timepoints).

In another variant, an effective residence time parameter is generated based on the residence time. In an example, the effective residence time is the effective amount of time the food instance has been cooking at a temperature that is different (e.g., lower or higher) than the measured cooking cavity temperature (e.g., which may fluctuate or which may be set to a non-optimal temperature). The effective residence time can be used instead of the residence time in any step of the method (e.g., if the user selects a non-optimal preheat temperature for a given food classification in S100, the effective residence time can be tracked for that food instance such that a target cook time at the optimal cooking temperature can be compared against the effective residence time).

The method can optionally include notifying a user when the residence time satisfies the cooking time S600. S600 can function to ensure a food instance does not overcook, to indicate that the user should check on or adjust the food instance (e.g., re-orient/relocate the food instance, add toppings, move to a next recipe stage, etc.), to ask the user to perform an action, and/or to elicit information from the user (e.g., does the food instance need additional time, whether the user has performed an action, etc.).

S600 can occur during a cook session/subsession, separate from a cook session/subsession, before a residence time satisfies the cook time (e.g., a predetermined time beforehand to ensure the user checks on the food instance), when the residence time satisfies (e.g., meets, nears, etc.) the cook time (e.g., within 10 min, 5 min, 1 min, 30 sec, 10 sec, 5 sec, 1 sec, a predetermined percentage of the total cook time, a user selected time, etc.), after the residence time satisfies the cook time (e.g., a reminder notification), and/or at any other suitable time. Preferably, S600 occurs without adjusting the cooking temperature and/or changing the target output for the set of heating elements based on the residence time satisfying the cooking time. Alternatively, S600 can automatically adjust the heating element instructions and/or adjust the heating element instructions based on the user response (or lack of response) to the notification.

Notifying a user can include determining a user action (e.g., turn off the appliance, turn on the appliance, insert a food instance, remove a food instance, re-orient a food instance, modify the food instance, adjust the cooking temperature, check on the food instance, proceed to a next cooking/recipe stage, etc.) for which to communicate to the user. The user action can be determined based on the residence time satisfying the cook time, the detection of a transition event, a user action conflicting with a cavity state (e.g., heating the oven while a food instance is present), a cooking cavity measurement from one or more sensors (e.g., a sensor indicating a food instance burning), and/or any other event. The notification can be received on: on the appliance, on a user device (e.g., a smartphone), and/or otherwise received by the user. The notification can be a push notification, text message, email, phone call, audio tone or message, and/or any other notification. The notification can include the user action, the residence time, the cook time, a time difference between the cook time and the residence time, one or more cooking cavity measurements and/or processed cooking cavity measurements (e.g., determined event, class label, etc.), transition event classifications (e.g., based on the transition event module), any other classification, the set cooking temperature, and/or any other suitable information. The notification can be sent directly to a user and/or indirectly to a user (e.g., to a server, which can forward the notification and/or send a generated notification to the user). The notification can additionally or alternatively be stored in the datastore for later use.

Notifying a user can additionally or alternatively include performing any other action. In an example, S600 includes automatically moving the food instance to another part of the appliance (e.g., warming chamber, cooler location within the cooking cavity, etc.). In another example, S600 includes ejecting the food from the cooking cavity. In another example, S600 includes deploying increasingly invasive notifications over time (e.g., to ensure the user turns off the heating elements, checks on the food instance, etc.). In another example, S600 includes adding time to the cook time, S800.

The method can optionally include detecting occurrence of a termination event, wherein the residence time tracker can be stopped upon termination event detection. The termination event can include: a food removal event (e.g., as determined in S200, above), a predetermined series of door or cavity states (e.g., door opening and closing), a user input (e.g., pausing the residence time tracker), satisfaction of the cook time (e.g., the residence time substantially satisfying the cook time), and/or any other suitable termination event. Cavity heating S100 preferably continues through termination event detection, but can alternatively be terminated upon termination event detection or otherwise managed.

The method can optionally include storing a residence time S700. S700 can function to store information for use in subsequent cook sessions/subsessions. Preferably, S700 occurs after S500 and/or in response to a transition event detection S200 (e.g., termination event detection), but alternatively can occur at any other suitable time. Preferably, the residence time is stored in the datastore onboard the appliance or in the cloud. Alternatively, the residence time can be stored in any other location. The residence time to store can be determined as described in S500 (e.g., final residence time for session/subsession, residence time and cooking temperature relationship, in response to user input, etc.), or be otherwise determined. This stored residence time can be used in determining the cook time of a subsequent cook session/subsession as described in S400 for the same or different food instance, otherwise used, or not used. The stored residence time can be specific to a cook context, a user, an appliance, one or more food classifications, a cooking temperature, a food size/weight/amount, and/or any other suitable parameter.

However, the residence time can be otherwise stored.

The method can optionally include adjusting the cook time S800. S800 can function to adjust and/or personalize the cook time for one or more cooking sessions and/or subsessions. In one variant, if a re-insertion event or a checking event is detected S200 after the residence time has exceeded the target cook time, the determined target cook time S400 is increased by a predetermined amount. In an example, the predetermined amount is determined based on the food classification. In another variant, a user input is used. In an example, a user confirms one or more suggested times to add to the target time or a time after current time (e.g., 5 min from the current time). In another example, a user manually inputs an adjusted time/added time.

Alternative embodiments implement the above methods and/or processing modules in non-transitory computer-readable media, storing computer-readable instructions, that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method comprising:
heating a cooking cavity to a cooking temperature;
while controlling a set of heating elements to maintain the cooking temperature:
detecting insertion of a food instance into the cooking cavity;
determining a food classification for the food instance based on an image depicting the food instance within the cooking cavity;
determining a cooking time based on the food classification;
tracking a residence time of the food instance within the cooking cavity responsive to insertion detection; and
controlling operation of a secondary device when the residence time is near the cooking time.

2. The method of claim 1, further comprising:
detecting removal of the food instance;
storing a final residence time of the food instance in association with the food classification responsive to removal detection;
detecting insertion of a second food instance;
classifying the second food instance with the food classification based on a second image depicting the second food instance within the cooking cavity;
determining a second cooking time based on the final residence time retrieved based on the food classification;
tracking a second residence time of the second food instance within the cooking cavity responsive to insertion detection of the second food instance; and
controlling operation of the secondary device when the second residence time is near the second cooking time.

3. The method of claim 1, wherein the cooking time is further determined based on a location of the food instance within the cooking cavity.

4. The method of claim 1, further comprising setting a clock to count up based on the residence time.

5. The method of claim 1, further comprising:
detecting removal of the food instance;
pausing the residence time tracking responsive to removal detection;
detecting insertion of an unknown food instance;
determining whether the unknown food instance is the food instance based on a comparison between a pre-removal image depicting the food instance and a re-insertion image depicting the unknown food instance within the cooking cavity; and
resuming tracking the residence time when the unknown food instance is the food instance.

6. The method of claim 5, further comprising determining a second cooking time and tracking a second residence time when the unknown food instance is different from the food instance, wherein the second cooking time is determined based on the residence time at removal detection of the food instance when the unknown food instance shares the food classification with the food instance.

7. The method of claim 1, wherein a set of control instructions for the set of heating elements are not dynamically adjusted to achieve a different cooking temperature during food instance residency within the cooking cavity.

8. The method of claim 1, further comprising:
classifying an accessory as empty or occupied based on an image depicting the accessory within the cooking cavity;
not tracking the residence time when the accessory is classified as empty; and
tracking the residence time when the accessory is classified as occupied.

9. The method of claim 1, further comprising:
detecting a food actuation event;
pausing tracking of the residence time responsive to detection of the food actuation event;
determining a food classification of an unknown food instance based on an image of the unknown food instance within the cooking cavity after detecting the food actuation event;
classifying the unknown food instance as cooked or uncooked based on the image of the unknown food instance;
resuming tracking of the residence time when the unknown food instance shares the food classification with the food instance and is classified as cooked;
restarting residence time tracking when the unknown food instance is classified as uncooked; and
restarting residence time tracking when the food classification for the unknown food instance is different from the food classification for the food instance.

10. A system comprising:
a cooking appliance comprising a cooking cavity and a set of heating elements;
a processor configured to:
heat the cooking cavity to a cooking temperature; and
while controlling the set of heating elements to maintain the cooking temperature:
detect insertion of a food instance into the cooking cavity;
determine a food classification for the food instance based on an image depicting the food instance within the cooking cavity;
determine a cooking time based on the food classification;
track a residence time of the food instance within the cooking cavity responsive to insertion detection; and
control operation of a secondary device when the residence time is near the cooking time.

11. The system of claim 10, wherein the cooking appliance is an oven.

12. The system of claim 11, wherein the cooking appliance further comprises a camera system mounted to the cooking cavity and wherein the image is sampled by the camera system.

13. The system of claim 10, wherein the cooking appliance is a grill.

14. The system of claim 13, wherein the image is sampled by a smartphone camera system.

15. The system of claim 10, wherein the processor is further configured to:
detect removal of the food instance;
store a final residence time of the food in association with the food classification responsive to removal detection;
detect insertion of a second food instance;
classify the second food instance with the food classification based on a second image depicting the second food instance within the cooking cavity;
determine a second cooking time based on the final residence time retrieved based on the food classification;
track a second residence time of the second food instance within the cooking cavity responsive to insertion detection of the second food instance; and
control operation of the secondary device when the second residence time is near the second cooking time.

16. The system of claim 15, wherein the processor does not dynamically adjust control instructions for the set of heating elements between food instance insertion into the cooking cavity and removal detection of the second food instance from the cooking cavity.

17. The system of claim 10, wherein the processor is further configured to:
detect a food actuation event;
pause tracking of the residence time responsive to detection of the food actuation event;
determine a food classification of an unknown food instance based on an image of the unknown food instance within the cooking cavity after detecting the food actuation event;
classify the unknown food instance as cooked or uncooked based on the image of the unknown food instance;
resume tracking of the residence time when the unknown food instance shares the food classification with the food instance and is classified as cooked;
restart residence time tracking when the unknown food instance is classified as uncooked; and
restart residence time tracking when the food classification for the unknown food instance is different from the food classification for the food instance.

18. The system of claim 13, wherein the processor is further configured to:
detect a reorientation event of the food instance;
store a primary residence time of the food instance based on the residence time at a time of the reorientation event;
determine a secondary cooking time based on the food classification and the primary residence time;
track a secondary residence time of the food instance in the cooking cavity after the reorientation event; and
control the secondary device operation when the secondary residence time is near the secondary cooking time.

19. The system of claim 10, wherein the processor does not dynamically adjust control instructions for the set of heating elements between food instance insertion into the cooking cavity and food instance removal from the cooking cavity.

20. The system of claim 10, wherein the processor does not determine a cooking temperature based on the food classification determined based on the image depicting the food instance within the cooking cavity.
